(19) United States
(12) Patent Application Publication
(10) Pub. No.: US 2004/0236830 A1
(43) Pub. Date: Nov. 25, 2004

(54) Annotation management system

(76) Inventors: Steve Nelson, San Jose, CA (US); Jason Harris, Mountain View, CA (US)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/440,526

(22) Filed: May 15, 2003

(51) Int. Cl. G06F 15/16

(52) U.S. Cl. 709/204

(57) ABSTRACT

An annotation management system for providing real-time annotations for media content during a videoconference session is provided. The annotation management system includes a media management server configured to manage media data and annotation data for distribution to participants of the videoconference session. A storage server in communication with the media management server is configured to store the media data and the annotation data. An event database in communication with the media management server is configured to capture events associated with the annotation data. A media analysis server is in communication with the media management server, the event database, and the storage server. The media analysis server is configured to associate the stored annotation data with the captured events to enable reconstruction of the videoconference session based on the captured events. A videoconference system, a computer readable medium, a graphical user interface, and a method are also included.

### CROSS REFERENCE TO RELATED APPLICATIONS

This application is related to U.S. patent application Ser. No. ______ (Attorney Docket No. AP154HO), filed on the same day as the instant application and entitled “Method and System for Media Playback Architecture.” This application is also related to U.S. patent application Ser. No. 10/192,080 filed on Jul. 10, 2002 and entitled “Multi-Participant Conference System with Controllable Content Delivery Using a Client Monitor Back-Channel.” Both of these related applications are hereby incorporated by reference for all purposes.

### BACKGROUND OF THE INVENTION

1. Field of the Invention

This invention relates generally to videoconferencing systems and more particularly to an annotation management system configured to provide participants the capability of exchanging annotation data during a videoconference session.

2. Description of the Related Art

Conferencing devices are used to facilitate communication between two or more participants physically located at separate locations. Devices are available to exchange live video, audio, and other data to view, hear, or otherwise collaborate with each participant. Common applications for conferencing include meetings/workgroups, presentations, and training/education. Today, with the help of videoconferencing software, a personal computer with an inexpensive camera and microphone can be used to connect with other conferencing participants. The operating systems of some of these machines provide simple peer-to-peer videoconferencing software, such as MICROSOFT'S NETMEETING application that is included with MICROSOFT WINDOWS based operating systems. Alternatively, peer-to-peer videoconferencing software applications can be inexpensively purchased separately. Motivated by the availability of software and inexpensive camera/microphone devices, videoconferencing has become increasingly popular.

A shortcoming associated with video conferencing units is the ability for a participant to view annotations in real-time. While some systems provide the ability to be notified of annotations through electronic mail (email), the participants are not notified in real-time. In addition, the participant must access the annotation notification email through a separate application from the videoconference application. Furthermore, once the annotations are made, there is no mechanism for reconstructing the annotations for future reference. Thus, if a person misses the videoconference session for whatever reason, the data is lost.

As a result, there is a need to solve the problems of the prior art to provide a method and system for enabling the capability of exchanging annotation data among participants in real-time. In addition, the videoconference system should be able to capture the annotation data so that a record of the annotations for the videoconference session may be reconstructed.

### SUMMARY OF THE INVENTION

Broadly speaking, the present invention fills these needs by providing a method and system for enabling the participants to exchange annotation data in real-time, where the annotation data is preserved so that the videoconference session may be reconstructed. It should be appreciated that the present invention can be implemented in numerous ways, including as a process, a system, a computer readable media, or a graphical user interface. Several inventive embodiments of the present invention are described below.

In one embodiment, a videoconference system is provided. The video conference system includes a plurality of clients and a server component configured to distribute media to the plurality of clients. A conference channel comiunication connection over which video and audio data streams are carried between the plurality of clients and the server component is included. An annotation management system configured to manage and store annotation data and annotation control data is provided. The annotation management system is in communication with the server component. A back-channel communication connection over which the annotation data and the annotation control data are communicated between the plurality of clients, the server component and the annotation management system is included.

In another embodiment, a videoconferencing system enabling participants to exchange annotation information is provided. The videoconference system includes a server component. A client configured to execute application software enabling interaction between the client and the server component is included. The interaction between the client and the server includes sharing real-time annotation data between clients. An annotation management system in communication with the server component is provided. The annotation management system is configured to manage and store the real-time annotation data.

In yet another embodiment, an annotation management system for providing real-time annotations for media content during a videoconference session is included. The annotation management system includes a media management server configured to manage both media data and annotation data for distribution to participants of the videoconference session. A storage server in communication with the media management server is provided. The storage server is configured to store the media data and the annotation data. An event database in communication with the media management server is included. The event database is configured to capture events associated with the annotation data. A media analysis server in communication with the media management server, the event database, and the storage server is included. The media analysis server is configured to associate the stored annotation data with the captured events to enable reconstruction of the videoconference session based on the captured events.

In still yet another embodiment, a graphical user interface (GUI) enabled to provide real-time annotation of display data rendered on a display screen is provided. The display data is associated with a videoconference session. The GUI includes a media display region corresponding to a media signal. The media display region is capable of being annotated by a videoconference participant, wherein the annotation of the media display region generates an event for storage on an annotation management server. The annotation of the media display region further generates a signal presented to remaining videoconference participants in real-time. A control display region enabling a participant to define control properties associated with the media display region is included.

In still yet another embodiment, a method for providing real-time annotation data to clients of a videoconference session is provided. The method initiates with annotating a display region of a user interface associated with a client of the videoconference session. Then, annotating of the display region is detected. In response to detecting the annotating of the display region, the method includes communicating data corresponding to the detecting of the annotating of the display region to other clients of the videoconference session for real-time presentation. Next, the data corresponding to the detecting of the annotating of the display region is stored. Then, the data corresponding to the detecting of the annotating of the display region is associated with data defining the videoconference session.

In another embodiment, a computer readable media having program instructions for providing real-time annotation data to clients of a videoconference session is provided. The computer readable media includes program instructions for annotating a display region of a user interface associated with a client of the videoconference session and program instructions for detecting the annotation of the display region. Program instructions for communicating data corresponding to the detection of the annotation of the display region to other clients of the videoconference session for real-time presentation are included. Program instructions for storing the data corresponding to the detection of the annotation of the display region and program instructions for associating the data corresponding to the detection of the annotation of the display region with data defining the videoconference session are provided.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a schematic diagram illustrating the components for a multi-participant conference system using a client monitor back-channel in accordance with one embodiment of the invention.

FIG. 2 is a simplified schematic diagram illustrating the relationship between modules of the annotation management system in accordance with one embodiment of the invention.

FIG. 3 is a schematic diagram illustrating a plurality of conference client configurations in accordance with one embodiment of the present invention.

FIG. 4 illustrates an exemplary administrator console graphical user interface (GUI) in accordance with one embodiment of the invention.

FIG. 5A illustrates an exemplary conference room GUI in accordance with one embodiment of the present invention.

FIG. 5B is an exemplary implementation of a conference room GUI in accordance with one embodiment of the present invention.

FIG. 6 illustrates a desktop client GUI which is configurable to interact with embodiments of the present invention.

FIG. 7A illustrates an exemplary desktop client GUI in accordance with one embodiment of the invention.

FIG. 7B is an exemplary implementation of a desktop client GUI in accordance with one embodiment of the present invention.

FIG. 8 is a simplified schematic diagram of a conference room configuration in which video conference participants view a video conference session from a liquid crystal display (LCD) projector in accordance with one embodiment of the invention.

FIG. 9 is a flow chart diagram illustrating the method operations for providing real-time annotation data to clients of a video conference session in accordance with one embodiment of the invention.

### DETAILED DESCRIPTION OF THE PREFERRED EMBODIMENTS

An invention is described for an apparatus and method for an annotation management system configured to enable clients of a videoconference session to share annotation data in real-time and to provide for the storage of the videoconference session in a manner that enables reconstruction of the videoconference session based upon the annotation data. The annotation management system further provides a virtual pointer that is shared between the clients of the videoconference session. It will be apparent, however, to one skilled in the art, in light of this disclosure, that the present invention may be practiced without some or all of these specific details. In other instances, well 10 known process operations have not been described in detail in order not to unnecessarily obscure the present invention. The term “about” as used herein refers to +/−10% of the referenced value.

The embodiments of the present invention provide a method and system for enabling real-time annotation features that may be viewed by participants of a videoconference system. In addition, virtual pointer functionality is provided so that a videoconference participant may emphasize, highlight or distinguish a portion of the user interface displayed by each of the clients associated with the videoconference participants. Data corresponding to the videoconference session e.g., annotation data generated by the participants during the videoconference session, is stored by the annotation management server. Properties associated with the annotation data, such as the time of each annotation in the videoconference session, the origination of the annotation data, etc., are managed by the annotation management system.

The annotation data is associated with the videoconference session data through the properties, e.g., time of annotation, origination of annotation, etc., thereby enabling reconstruction of the videoconference session based upon the annotation data. For example, if a person interested in the videoconference session was unable to attend the videoconference session, the meeting may be reconstructed according to the preferences of the person interested in viewing the videoconference session. That is, the videoconference session may be reconstructed to present all the comments/annotations for a particular slide presentation, document, photograph, etc. In addition, notes on a virtual whiteboard corresponding to the particular slide presentation, document, photograph, etc., may also be identified to be included in the reconstructed videoconference session as well as any other virtual pointer/virtual ink data.

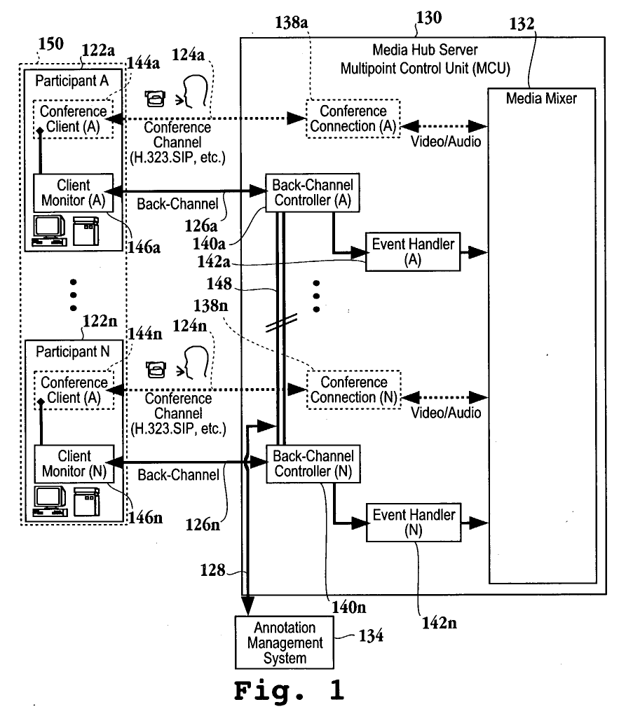

FIG. 1 is a schematic diagram illustrating the components for a multi-participant conference system using a client monitor back-channel in accordance with one embodiment of the invention. The client component includes multiple participants, such as participant A 122a through participant N 122n. In this embodiment, each participant 122a-122n includes conference client 144 and client monitor 146. Conference client A 144a may include the participant's peer-to-peer videoconferencing software or any proprietary videoconferencing software application. It should be appreciated that each participant may place calls to another participant, establish and disconnect a conferencing session, capture and send content, receive and playback the content exchanged, etc. Calls from each of the conference clients route through media transport server 130. That is, the participants use their associated conference client to place calls to media transport server 130 to join the conference. In one embodiment, conference client A 144a includes a high-level user-interface for the conference, such as when the conference client is a pre-existing software application. For example, one such product that provides peer-to-peer videoconferencing is the NETMEETING application software from MICROSOFT Corporation.

CM 146a is configured to monitor conference client A 144a. That is, CM 146a looks at how a user is interacting with the software application by monitoring a video display window of client A 144a in one embodiment. In addition, CM 146a interprets the users interactions in order to transmit the interactions to the server component. In one embodiment, CM 146 is configured to provide four functions. One function monitors the start/stop of a conference channel so that a back-channel communication session can be established in parallel to a conference channel session between the participant and the server component. A second function monitors events, such as user interactions and mouse messages, within the video window displayed by conference client 144. A third function handles control message information between the CM 146 and a back-channel controller 140 of the server component. A fourth function provides an external user-interface for the participant that can be used to display and send images to other conference members, show the other connected participants names, and other communication information or tools.

As mentioned above, the client monitor watches for activity in the associated conference client. In one embodiment, this includes monitoring user events over the video display region containing the conference content, and also includes the conference session control information. For example, CM 146 watches for the start and end of a conference session or a call from the conference client. When conference client 144 places a call to media transport server 130 to start a new conference session, CM 146 also places a call to the media transport server. The call from CM 146 establishes back-channel connection 126 for the participant's conference session. Since CM 146 can monitor the session start/stop events, back-channel connection initiates automatically without additional user setup, i.e., the back-channel connection is transparent to a user. Accordingly, a new session is maintained in parallel with conference client 144 activity. It should be appreciated that conference channels 124a-124n provide a video/audio connection between the associated conference client 144 and conference connection 138 of media transport server 130. In one embodiment, conference channel 124 provides a communication link for real-time video/audio data of the conference session communicated between the client component and the server component.

CM 146 may specifically monitor activity that occurs over the conference's video frame displayed by conference client 144. For example, CM 146 may monitor the video image in MICROSOFT'S NETMEETING application. Mouse activity in the client frame is relayed via protocol across back-channel connection 126 to media transport server 130. In turn, back-channel controller 140 can report this activity to another participant, or event handler 142 for the respective participant. In this embodiment, the monitoring of conference client 144 application occurs through a hook between the operating system level and the application level. As mentioned above, the video window can be watched for mouse clicks or keyboard strokes from outside of the videoconferencing application. Alternatively, proprietary videoconferencing application software may be provided which integrates the client monitor functionality to provided relevant information to a back-channel network.

In another embodiment, CM 146 can present a separate user-interface to the participant. This interface can be shown in parallel to the user interface presented by conference client 144 and may remain throughout the established conference. Alternatively, the user interface presented by CM 146 may appear before or after a conference session for other configuration or setup purposes.

In yet another embodiment, CM 146 may provide an interface for direct connection to a communication session hosted by media transport server 130 without need for a conference client. In this embodiment, CM 146 presents a user interface that allows back-channel connection 126 to be utilized to return meeting summary content, current meeting status, participant information, shared data content, or even live conference audio. This might occur, for instance, if the participant has chosen not to use conference client 144 because the participant only wishes to monitor the activities of the communication. It should be appreciated that the client component can be referred to as a thin client in that conference client 144 performs minimal data processing. In short, any suitable videoconference application may be included as conference client 144. As previously mentioned, CM 146a is configured to recognize when the videoconference application of conference client A 144a starts and stops running, in turn, the CM can start and stop running as the conference client does. CM 146a can also receive information from the server component in parallel to the videoconference session. For example, CM 146a may allow participant A 122a to share an image during the conference session. Accordingly, the shared image may be provided to each of the client monitors so that each participant is enabled to view the image over a document viewer rather than through the video display region of the videoconference software. As a result, the participants can view a much clearer image Of the shared document. In one embodiment, a document shared in a conference is available for viewing by each of the clients.

The server component includes media transport server 130, which provides a multi-point control unit (MCU) that is configured to deliver participant customizable information. It should be appreciated that media transport server 130 and the components of the media transport server are software code configured to execute functionality as described herein. In one embodiment, media transport server 130 is a component of a hardware based server implementing the embodiments described herein. Media transport server 130 includes media mixer 132, back-channel controller 140, and event handler 142. Media transport server 130 also provides conference connection 138. More specifically, conference connection A 138a completes the link allowing the videoconferencing software, e.g., a peer-to-peer videoconferencing application, of conference client A 144a to communicate with media transport server 130. That is, conferencing endpoint 138a emulates another peer and performs a handshake with conference client A 144a, which is expecting a peer-to-peer connection. In one embodiment, media transport server 130 provides Multipoint Control Unit (MCU) functionality by allowing connections of separate participants into selectable logical rooms for shared conference communications. As an MCU, media transport server 130 acts as a “peer” to a conference client, but can also receive calls from multiple participants. One skilled in the art will appreciate that media transport server 130 internally links all the participants of the same logical room, defining a multi-participant conference session for each room, with each peer-to-peer conference client operating with the media hub only as a peer. As mentioned above, media transport server 130 is configured to conform to the peer requirements of the associated conference client. For example, if the conference clients are using H.323 compliant conference protocols, as found in applications like MICROSOFT'S NETMEETING, media transport server 130 must also support the H.323 protocol. In other words, the conference communication can occur via H.323 protocols, Session Initiated Protocols (SIP), or other suitable APIs that match the participant connection requirements.

Still referring to FIG. 1, media mixer 132 is configured to assemble audio and video information specific to each participant from the combination of all participants' audio and video, the specific participant configuration information, and server user-interface settings. Media mixer 132 performs multiplexing work by combining incoming data streams, i.e., audio/video streams, on a per participant basis. In one embodiment, media mixer 132 includes a video layout processor and an audio distribution processor which assemble the conference signals. A client monitor-back-channel network allows media transport server 130 to monitor a user's interactions with conference client 144 and to provide the appearance that the peer-to-peer software application has additional functionality. The additional functionality adapts the peer-to-peer functionality of the software application, executed by conference client 144, for the multi-participant environment described herein. The client monitor-back-channel network includes client monitor 146 back-channel connection 126, back-channel controller 140, and event handler 142.

Back-channel connections 126a-126n are analogous to a parallel conference in addition to conference channels 124a-124n, respectively. Back-channel controllers (BCCs) 140a-140n maintain the communication link from each associated client monitor. Protocols defined on the link are interpreted at media transport server 130 and passed to the appropriate destinations, i.e., other participant's back-channel controllers, event handler 142, or back to the CM 146. Each of the back-channel controllers 140a-140n are in communication through back-channel controller communication link 148.

In one embodiment, media transport server 130 provides a client configurable video stream containing a scaled version of each of the conference participants. A participant's event handler 142 in media transport server 130 is responsible for maintaining state information for each participant and passing this information to media mixer 132 for construction of that participants user-interface. In another embodiment, a server-side user-interface may also be embedded into the participant's video/audio streams. Further details on the architecture illustrated by FIG. 1 may be found in U.S. patent application Ser. No. 10/192,080 referenced above. This application is herein incorporated by reference for all purposes. It should be appreciated that FIG. 1 represents one particular architecture for media transport server and the client component. It will be apparent to one skilled in the art that media transport server 130 may be based on any suitable architecture that includes the back-channel functionality. In addition, the client component may include any suitable client software configurations that enable a view of the videoconference session. The client software configurations may range from commercially available software packages, i.e., NETMEETING, to proprietary software configurations which may be downloaded to a client through a distributed network, such as the Internet.

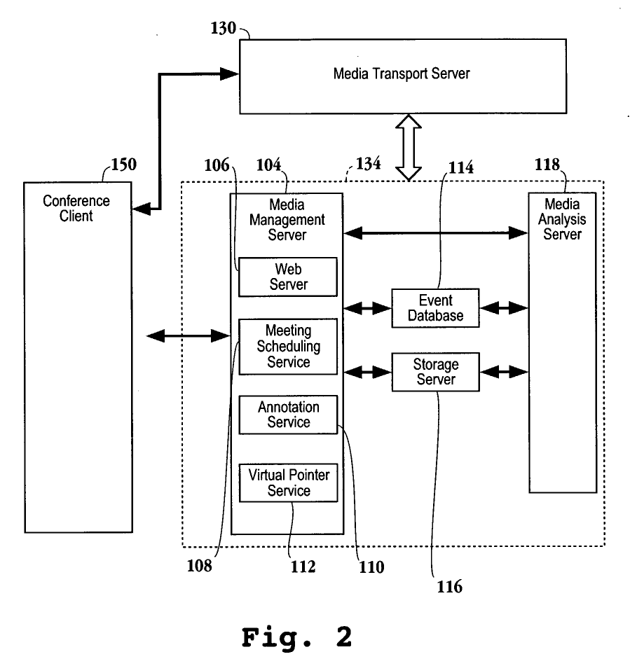

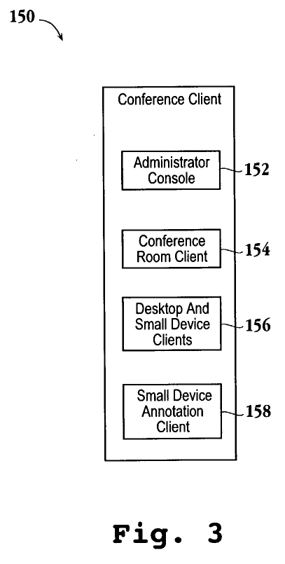

FIG. 2 is a simplified schematic diagram illustrating the relationship between modules of the annotation management system in accordance with one embodiment of the invention. It should be appreciated that the overall system architecture design of FIG. 2 may be in communication with any suitable video conferencing system, e.g., media transport server 130 of the video conferencing system depicted with reference to FIG. 1. The annotation management system of FIG. 2 is in communication with conference client 150 through media transport server 130. Conference client 150 may be configured as participants 122a-122n of FIG. 1. In addition, where conference client 150 represents multiple clients, each of the clients may be configured to execute the client application software configurations described with reference to FIG. 3. It should be appreciated that the annotation management system synchronizes annotations across all participants that are conversing.

Annotation management system 134 of FIG. 2 includes media management server 104. Media management server 104 includes web server module 106, meeting scheduling service module 108, annotation service module 110 and virtual pointer service module 112. In one embodiment, annotation service module 110 provides the functionality for a conference client to add annotation data during a videoconference session or view annotation data from a previously recorded videoconference session. Also included in annotation management system 134 is media analysis server 118, event database 114 and storage server 116. Media management server 104 manages and organizes the meeting, e.g., manages and organizes videoconference data for distribution among the participants of the meeting. Additionally, media management server 104 builds the database to manage the medias and allow the meeting participants to retrieve the media data from storage server 182. Media management server 104 also retrieves the information from media analysis sever 118 and any modules for media playback and presentation. The post-processing of the media data recorded during the meeting, i.e., videoconference session, is performed by media analysis server 118. Media analysis server 118 adds and retrieves information to event database 114, described in more detail below, to store the information for the media presentation and playback.

Storage server 116 is responsible for storing the media generated during a videoconference session which includes annotation data and virtual pointer data. For example, all sketches made during the meeting are captured and may be displayed as part of a meeting summarization. In one embodiment, the meeting summarization allows annotations to be viewed in the context of other events that take place during the meeting. In another embodiment, the annotation data will be stored on the storage server in vector format so that it can be scaled for display on devices of any output resolution.

As described with reference to FIG. 1, media transport server 130 handles the videoconference connections from the participants and combines the many incoming video and audio streams into a single output stream in the desired format for each participant/client. During a videoconference session, media transport server 130 communicates with media management server 104, informing the media management server of such details as when participants connect or disconnect.

Web server module 106 enables the downloading of any software code needed for participating or viewing the videoconference session. Meeting scheduling service module 108 enables a user to set up or join a videoconference session. That is, a user that desires to set up or join a videoconference session may do so through a web browser that may download hyper text markup language (HTML) type pages provided through web server module 106. Once the user has joined the video conference session, software code may be downloaded from web server 106, e.g., software code related to client functionality after which the client begins communicating with media transport server 130. It should be appreciated that through meeting scheduling service module 108, media management server 104 connects to the appropriate media transport server to enables the video conference session. In another embodiment, since the video conference session is stored, upon completion of the video conference session a meeting summary may be created. The meeting summary may be accessed through web server 106. The meeting summary is an overview of the meeting that may be presented to a user so that the user may better decide whether to view the meeting or what portions of the meeting to view. It will be apparent to one skilled in the art that the meeting summary may be presented in any number of suitable manners. Furthermore, the stored annotation data and stored virtual pointer data may be incorporated into the meeting summary to more accurately portray the meeting summary.

Media management server 104 is in communication with media analysis server 118. In one embodiment, media management server 104 retrieves the information from media analysis server 118 and associated modules for media playback and presentation. Media analysis server 118 is in communication with event data base 114 and storage server 116. As mentioned above, media analysis server 118 performs the post-processing of the media recorded during the meeting and analyzes the media to build information to be used for media presentation and playback. Media analysis server 118 may also add and retrieve annotation information to event database 114. In one embodiment, the annotation information is identified through the insertion of indices and markers into the stored videoconference data, thereby enabling reconstruction of the stored videoconference data based upon the annotation information. As used herein, annotation information may include virtual pointer information. Virtual pointer information may refer to mouse moves transmitted to media management server and then distributed out to participants so that each participant may view the mouse moving within the associated client display. It should be appreciated that annotation management information may be referred to as virtual ink. In another embodiment, the annotation information includes the data stored in event data base 114 as discussed below.

Storage server 116 of FIG. 2 is configured to store media associated with the videoconference. Storage server 116 is responsible for storing any suitable media utilized for the videoconference session. In one embodiment, storage server 116 contains storage devices, such as hard drives, magnetic tapes, and DVD-Rom, etc. Access to the stored media may be provided through a set of application programming interfaces (APIs) defined for accessing the medias that may be retrieved from storage server 116 by other components in the system. In another embodiment, storage server 116 accepts network connections for users or participants of the videoconference to upload their medias. Exemplary mechanisms for uploading the medias to the storage server include: Simple transport control protocol/Internet protocol (TCP/IP) socket connection, hypertext transport protocol (HTTP) file upload protocol, simple object oriented access protocol (SOAP/XML), and other suitable network transport protocols. Event database 114 of FIG. 2 stores annotation events occurring during the videoconference session. Exemplary annotation events include the following: the annotation start point, the annotation end point, an annotation clear page, the annotation data, user information associated with the annotation start and the annotation end, the annotation target, e.g., type of media, a target identifier, and other suitable annotation information.

FIG. 3 is a schematic diagram illustrating a plurality of conference client configurations in accordance with one embodiment of the present invention. As described above, a video-conferencing system implementing the embodiments of the present invention includes a client-server application solution for managing, transporting, and analyzing annotation data. In one embodiment of the invention, the client side of the client-server application solution includes conference client 150. Conference client 150 includes any of a plurality of client software configurations implemented in a plurality of client hardware devices and configurations. FIG. 3 illustrates a plurality of exemplary conference clients 150, and it should be understood that the exemplary conference clients 150 are illustrative of envisioned types and configurations of conference clients, and the list should not considered to be exhaustive or limiting.

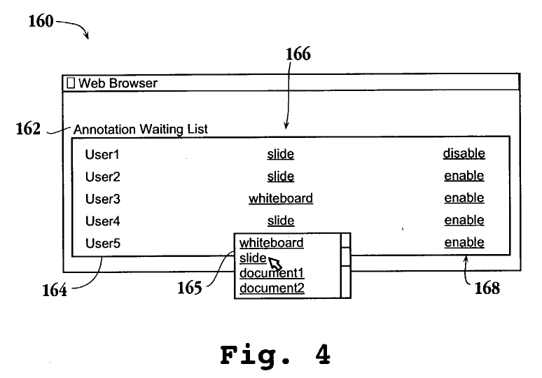

In one embodiment of the present invention, one or more of the conference clients 150 may be configured as an administrator client 152, a conference room client 154, desktop and small device clients 156, small device annotation clients 158, or any other client devices and configurations as might be usefully and effectively implemented in a client-server video conferencing system. Conference clients 150 may or may not include all of the illustrated or envisioned components depending on specific implementations, needs, and/or desires of particular conference settings. The illustrated components are briefly described below, and further illustrated with exemplary implementations in FIGS. 4, 5A, 5B, 6, 7A, and 7B.

An administrator client 152, in one embodiment, is provided to control various functions and available features for conference participants. By way of example, a conference or meeting administrator might be a presenter or presenter's assistant enabled to control the flow of the meeting. Such control might include, for example, PowerPoint slide changes, document distribution and display, use of a virtual pointer, setting the volume level for audio feeds of remote participants for orderly question and answer or other contributory sessions, controlling access to the current whiteboard, slide, or other media for annotations, etc. In one embodiment, if the administrator is presenting in a conference room, the administrator client 152 might be implemented on a handheld wireless device, e.g., a pocket personal computer in communication with such as a Compaq IPAQ connected to the video conferencing system. In another embodiment, if the administrator is using a desktop system, the administrator client might be implemented in a window on the desktop system. An exemplary administrator console graphical user interface (GUI) is illustrated in FIG. 4.

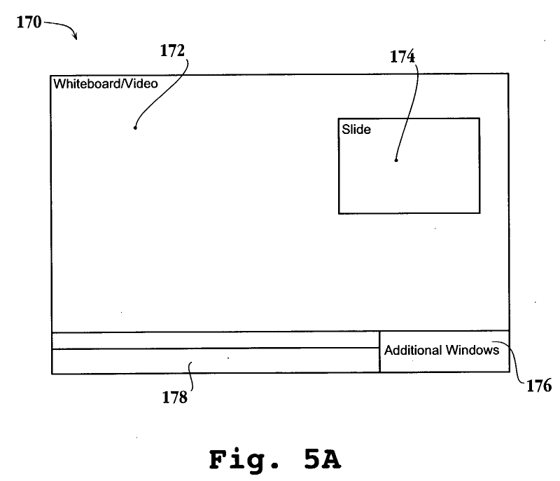

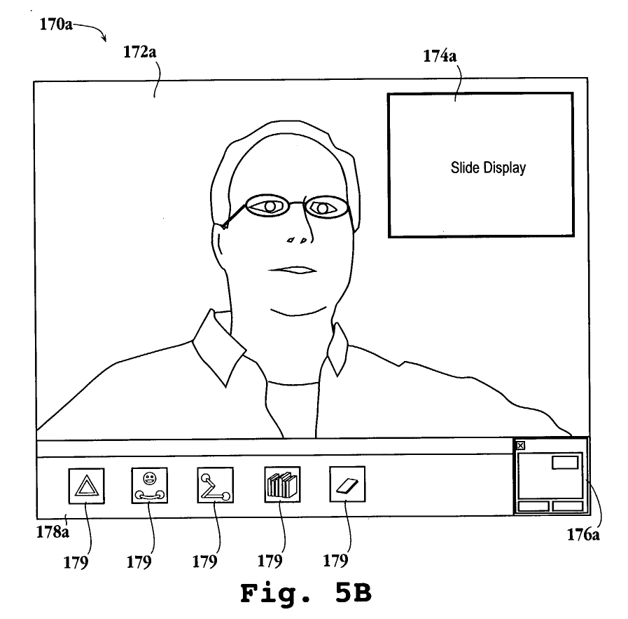

A conference room client 154, in one embodiment, is a conference client configuration for presenting a large screen display and providing additional media functionality that can be provided to a conference room setting. By way of example, an LCD projector might be used as the main display in the conference room as illustrated with reference to FIG. 8. The LCD projector is connected to a client system configured as a conference room client. The conference room client presents a full screen display with a picture-in-picture capability configurable for a POWERPOINT presentation, whiteboard display, video feed, etc. In one embodiment, a conference room moderator can display the videoconference feed in the full screen with a small window for the POWERPOINT slide or vice versa. In another embodiment, conference participants in the conference room will use the small device annotation client described below to annotate. Exemplary conference room client GUIs are illustrated in FIGS. 5A and 5B.

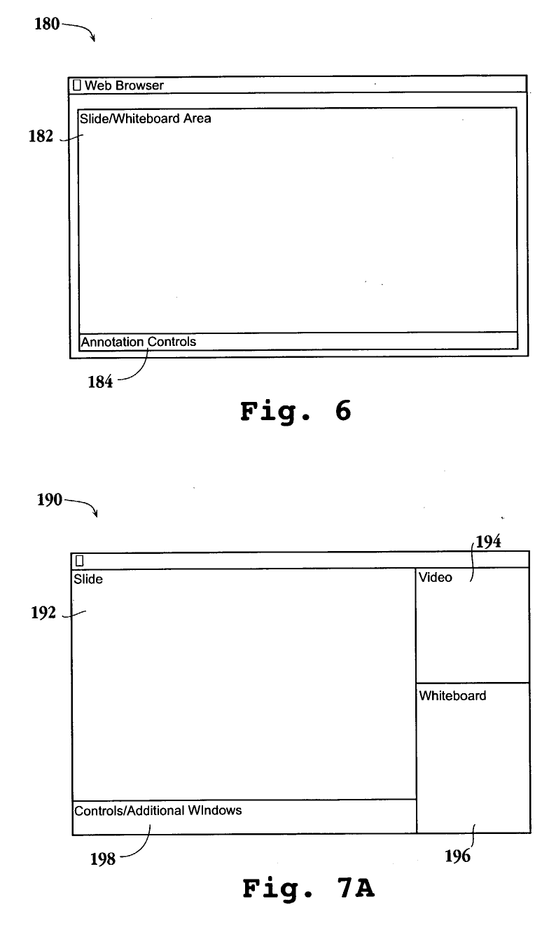

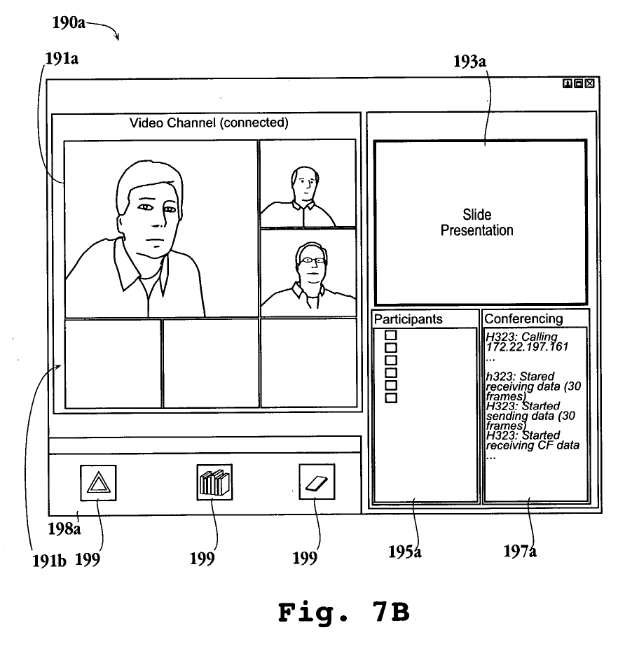

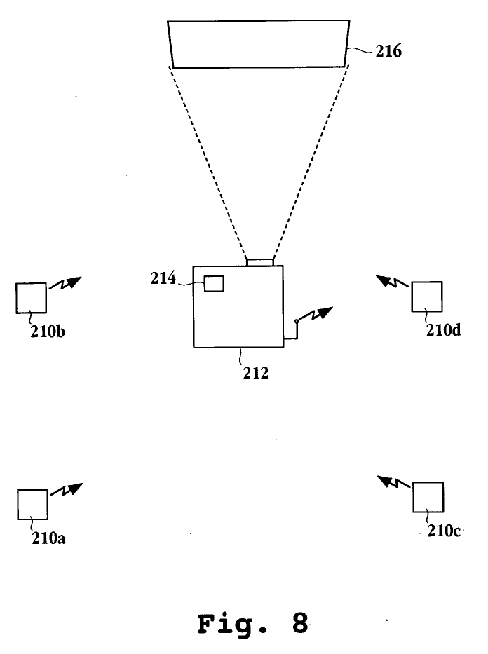

Desktop and small device clients 156 are conference client configurations implemented for participants using desktop systems and small wireless devices, such as a pocket personal computer, respectively, in one embodiment of the invention. A desktop client 156 is an application that connects remote desktop clients into the video conferencing system. In one embodiment, a desktop client 156 requires a program to be downloaded and installed to enable the functionality of the plurality of desktop client features as described herein. The desktop client 156 program provides an integrated view to the video conferencing system, and is consistent with the features and functionality of the various conference clients 150. In another embodiment, a participant can use readily available, simple, peer-to-peer video conferencing software such as MICROSOFT'S NETMEETING application that is included with MICROSOFT WINDOWS based operating systems as a desktop client 156. Embodiments of the present invention are compatible with NETMEETING, although NETMEETING does not include all of the features and functionality of embodiments of the present invention as described herein. An annotation module can be included with the desktop client 156 that will provide for annotation using a mouse or stylus, and described more fully below in reference to FIG. 2. Exemplary desktop client GUIs are illustrated in FIGS. 6, 7A, and 7B.

In addition to a desktop client 156, embodiments of the present invention provide for the use and implementation of small device clients 156. In one embodiment, a small device client 156 allows hand held devices, such as, e.g., a pocket personal computer, personal digital assistants, and cell phones to connect to the video conferencing system. Features enabled with a small device client 156 will depend on the capabilities of a particular device, and may include voice only, voice and video, e.g., video may be received if there is no camera associated with the device, POWERPOINT slide annotation, virtual pointer, photo upload, etc. It should be recognized that, depending on the small device used, some of the features or functionality of described features might be limited or unavailable. For example, a pocket personal computer client may only be able to receive low rate video images and a small POWERPOINT slide during a videoconference.

In one embodiment, a small device annotation client 158 is provided as a conference client 150. A small device annotation client 158 is a variation of the small device client 156 and can be used by participants in a conference room, for example, to annotate POWERPOINT slides, documents, whiteboard, etc. In one embodiment, a handheld device, such as those mentioned above, is connected using a wireless connection to the video conferencing system. Since the participants in the conference room might be viewing conference media on the LCD projector, the small device annotation client enables annotation by a participant seated at a conference table, for example, while viewing conference media on the LCD display as illustrated with reference to FIG. 8. In another embodiment, with the conference media displayed or otherwise presented on the large LCD display, the small device annotation client may not display a video media feed.

FIG. 4 illustrates an exemplary administrator console graphical user interface accordance with one embodiment of the invention. As described above, the administrator client enables control of various features and functionality available to conference clients. In one embodiment, the administrator client is enabled through a typical web browser window having usual and customary web browser functionality. By way of example, regions, phrases, or words within administrator console GUI 160 might be hyper-linked enabling access to additional administrative console pages, or enabling a selection of a function, or toggling of a state. Additionally, a cursor (not shown in FIG. 4) might change form over a hyper-linked region within the administrator console GUI 160, and assume a functionality to enable selection, toggling, etc.

In the embodiment illustrated in FIG. 4, one page of the administrator console GUI 160 is displayed. The illustrated page 162 is identified as the Annotation Waiting List. Other pages, or other control windows such as control over slide presentation, audio feed and volume control, video and whiteboard display, document display and distribution etc., are configured in various embodiments of the present invention. Annotation Waiting List 162 has, in the illustrated embodiment, three columns of selectable and/or configurable information. In one embodiment, a first column 164 includes a listing of all connected participants. A scrolling feature (not illustrated) may be included when the number of connected participants so warrants. A second column 166 shows available annotation media. As described above, a plurality of media may be configurable for annotation, including such media as whiteboard presentation, slide presentation, documents, etc. In one embodiment of the invention, the displayed media that may be configurable for annotation is selectable and/or can be toggled between the various media that may be available. By way of example, when a plurality of media capable of annotation are active in the system, each media may be presented as a hyper-link or underlined, or in some manner indicated to be selectable or capable of selecting to be toggled, be selected from a drop-down list, or other method of selection between the plurality of media. In the illustrated administrator console GUI 160, an exemplary drop down selection box 165 is shown. Upon selection, the status of the selected media for each user is indicated in a third column 168, as will be described below. In one embodiment, by toggling or otherwise switching between all media, annotation can be enabled or disabled by the administrator for each active media and for each user using the identified 162 annotation waiting list.

As indicated above, the third column 168 in the illustrated embodiment, indicates a status for the selected media identified in the second column 166 for each participant. In one embodiment, the status is indicated as enabled or disabled. In another embodiment, the status may be indicated as enabled, disabled, or not applicable (N/A) if, in the particular participant's configuration certain media is not available or configurable. An administrator may select the status for each selected media of each participant and toggle between status to enable or disable the media for each user as desired and available. In one embodiment, an administrator can, through the administrator client, enable one or more participants to have annotation rights for specific media, and disable the annotation rights as desired. In another embodiment, participants indicate to the system a request to annotate, and the administrator client displays a list of participants desiring annotation rights. In one embodiment only one participant at a time can annotate. In another embodiment, more than one participant at a time can be enabled to annotate.

FIG. 5A illustrates an exemplary conference room GUI in accordance with one embodiment of the present invention. As described above, one embodiment of conference room GUI 170 is an LCD projector display connected to a client system running a conference room client software application. In the illustrated embodiment, a whiteboard or video display region 172 is the primary display region of the conference room GUI 170. Slide display region 174 is shown as a picture-in-picture within the whiteboard or video display region 172. Control region 178 is shown across the bottom of conference room GUI 170, and additional window region 176 is shown in the bottom left corner of conference room GUI 170. In one embodiment, each of the illustrated display regions is configurable as desired. By way of example, whiteboard or video display region 172 might be a default display selection for a typical conference room setting in which a whiteboard is a primary feature. Alternatively, a PowerPoint slide presentation might be the primary or predominate feature of a particular conference, and therefore the region illustrated as the whiteboard or video display region would be configured to display a PowerPoint slide presentation. In that example, the area illustrated as the slide display region 174 might be configured to display a video feed of the presenter, a whiteboard display, documents, and so forth as desired. Each of the identified or designated display regions in the illustrated embodiment should be understood to be exemplary only, and fully configurable to present desired displays, or no displays, as appropriate for a specific conference room setting.

Control region 178, in one embodiment, includes controls to configure media display regions, adjust volume and other audio feed parameters such as muting, adding audio feed to the conference room client, access to additional media available in the system, and other suitable controls. Additional window region 176, in one embodiment, is a region of conference room GUI 170 configurable to add additional media display windows such as video feeds from conference participants in remote locations, documents, secondary whiteboards, and any other additional media available in the system.

In one embodiment of the invention, the conference room client provides a large display, traditional conference room setting to a videoconference having additional participants in one or more locations remote from the primary conference site. Conference room GUI 170 enables multi-media display and presentation to a large group of participants, in one embodiment, and through the use of a virtual pointer and annotation features, enables sharing and collaboration among a plurality of participants in one or more locations through the videoconference system of the present invention. By way of example, in a conference room, participants might view and interact in a meeting through the conference room GUI 170 connected to the videoconference system of the present invention. Annotation capabilities are provided to conference room participants, in one embodiment, by use of small device clients, such as a handheld electronic devices, connected wirelessly to the system as described above and running small device annotation client software. In essence, the handheld electronic devices may act as a remote control station for annotation and virtual pointer functionality. In one embodiment, an administrator using an administrator client on an administrator console controls participant annotation capabilities. Alternatively, participant annotation capabilities and parameters may be provided by system settings.

FIG. 5B is an exemplary implementation of a conference room GUI in accordance with one embodiment of the present invention. Media display and presentation windows or areas described above in reference to FIG. 5A are illustrated in FIG. 5B with exemplary media content. A whiteboard or video display region 172a is shown with a video feed content, and a slide display region 174a is shown with an exemplary presentation slide content. Display and other control region 178a is illustrated with a plurality of control icons 179 providing access to a plurality of display and content control features. Additional window region 176a is shown as configurable for additional media content or display control. As described above, the illustrated conference room GUI 170a is exemplary only, and each of the media display and presentation windows or region are fully configurable in one embodiment of the invention to accommodate the types and numbers of medias available and appropriate to a plurality of video conference settings.

FIG. 6 illustrates a desktop client GUI 180, such as Microsoft's NETMEETING desktop client, which is configurable to interact with embodiments of the present invention. As described above, NETMEETING desktop client provides a minimum functionality for a desktop client connecting to and interacting with embodiments of the present invention. In such a configuration, only a small component of an embodiment of the present invention is downloaded or transferred to a client desktop system to enable interaction and functionality with embodiments of the present invention. In a typical NETMEETING implementation, video conferencing is enabled and the accompanying browser is used to view conference presentations. In one embodiment, annotation is supported with an applet or ActiveX control in the browser. In another embodiment, a mouse or stylus is used to draw any annotations or control a virtual pointer being viewed among participants.

In the embodiment illustrated in FIG. 6, a slide or whiteboard display region 182 is shown in desktop client GUI 180. The slide or whiteboard display region 182 is used to display conference presentation media such as a PowerPoint slide presentation, a virtual whiteboard, or a designated media compatible with the selected commercially available desktop client. An annotation controls region 184 is provided to enable interaction and compatibility with the server functionality of presentation annotation. In one embodiment, annotation controls region 184 is created and enabled by the component of an embodiment of the present invention that is downloaded or transferred to a client desktop system, and includes virtual cursor and pointer selection and control buttons, icons, etc., used to control annotation in the slide or whiteboard display region 182.

FIG. 7A illustrates an exemplary desktop client GUI in accordance with one embodiment of the invention. Desktop client GUI 190 illustrates a full-feature embodiment for a client desktop. Conference media is displayed or otherwise presented in configurable media regions of desktop client GUI 190, illustrated in FIG. 7A as slide display region 192, video display region 194, and whiteboard display region 196. It should be understood that the illustrated embodiment is exemplary only, and each of the display regions are fully configurable for size, position in the desktop client GUI 190, media content, etc. In one embodiment of the invention, the desktop client, as represented by desktop client GUI 190, is an integrated application that has a plurality configurable windows to access features and functions of a videoconference system. In another embodiment, media presentation windows such as those illustrated at 192, 194, and 196 are configurable as desired in accordance with available conference media, kind and type of conference, number of conference participants and locations, etc. By way of example, a slide presentation may not be desired in a particular conference and the display region identified in FIG. 7A as the slide display region 192 may be re-configured to be a video display region, or a whiteboard display region, or a document display region, or any other desired media display region.

Controls and additional windows region 198 of desktop client GUI 190 contain control features using icons, selectable buttons, adjustable knobs or bars, etc., for participant use in one embodiment of the invention. A participant, by way of example, may be able to configure the media delivery and display to the desktop client to create an individualized conference experience through the desktop client GUI 190. Examples of controls include display configuration and layout settings, volume settings and muting, selecting and de-selecting media, annotation and virtual pointer controls, etc. In one embodiment, additional display windows for media presentation may be configured and displayed in controls and additional windows region 198.

FIG. 7B is an exemplary implementation of a desktop client GUI 190a in accordance with one embodiment of the present invention. As described above, each of the media presentation windows or regions are fully configurable to accommodate the available and desired media in one embodiment of the invention. In the desktop client GUI 190a illustrated in FIG. 7B, a video region 191a is defined having a plurality of video windows, of different sizes, showing multiple conference participants. Additional video windows are defined at 191b to be assigned media content as desired. A slide presentation region is defined at 193a with an exemplary presentation slide displayed. An on-line library is shown at 195a for accesses to available on-line media, and a document is displayed at 197a. Control region is defined at 198a with a plurality of exemplary control icons 199 providing access to a plurality of display and content control features. As described above, the illustrated desktop client GUI 190a is exemplary only, and each of the media display and presentation windows or regions are fully configurable in one embodiment of the invention to accommodate the types and numbers of medias available and appropriate to a plurality of video conference settings.

FIG. 8 is a simplified schematic diagram of a conference room configuration in which video conference participants view a video conference session from a liquid crystal display (LCD) projector in accordance with one embodiment of the invention. Here, in order to support annotation capabilities for participants in the conference room the system will support small devices, such as a pocket personal computer connected wirelessly to the network running a small device annotation client software. Thus, handheld electronic devices 210a through 210d communicate wirelessly with LCD projector 212, either directly or through the media management server described with reference to FIG. 2. LCD projector 212 includes processor 214 capable of running the conference room client software as described above. Alternatively, LCD projector 212 may be connected to a personal computer running the conference room client software. Handheld electronic devices 210a through 210d will execute the small device annotation client software as described above. Thus, when a user wishes to make an annotation or use virtual pointer functionality, the user may take a stylus in order to input data which is captured into the video conference session and presented on display screen 216.

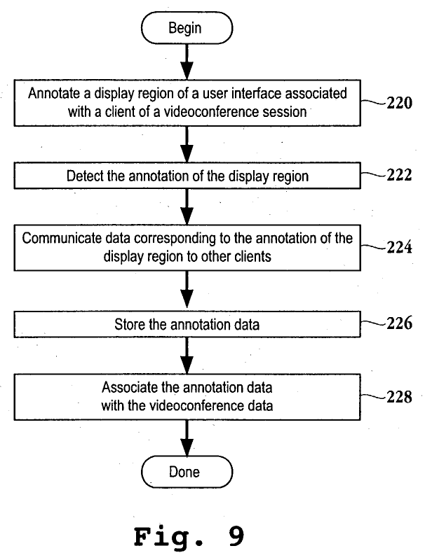

FIG. 9 is a flow chart diagram illustrating the method operations for providing real-time annotation data to clients of a video conference session in accordance with one embodiment of the invention. The method initiates with operation 220 where a display region of a user interface associated with a client of the video conference session is annotated. Here, a participant of the video conference session may annotate a display region through the use of a mouse, stylus, or some other input device in order to highlight, distinguish or somehow otherwise annotate the display region. The method then advances to operation 222 where the annotation of the display region is detected. For example, a client monitor or some similar functionality, as mentioned above, may detect the annotation of the display region. The method then proceeds to operation 224 where in response to detecting the annotation of the display region, data corresponding to the annotation of the display region is communicated to other clients of the videoconference session. Here, the back channel as discussed with reference to FIG. 1, is used to communicate the annotation of the display region to the media transport server which in turn communicates the annotation data to the annotation management system described with reference to FIG. 2. Accordingly, the real-time presentation of the annotation data is capable of being viewed by each participant of the videoconference session.

The method of FIG. 9 then moves to operation 226 where the annotation data is stored. For example, the annotation data may be stored as part of the captured videoconference data on the storage server as discussed with reference to FIG. 2. It should be appreciated that the associated properties of the annotation data are also stored. For example, the time of the annotation, the participant initiating the annotation, the type of media being annotated, etc., may all be captured and stored in the event database described with reference to FIG. 2. The method then advances to operation 228 where the properties of the annotation data which was stored is associated with the stored video conference data. For example, markers may be inserted into the stored videoconference data in order to identify where certain annotations took place. Here, the media analysis server may analyze and process the data from the storage server and the event database as required. Thus, a meeting sunmarization may be created from the stored data based upon the annotation data, i.e., the properties of the annotation data. It will be apparent to one skilled in the art that the storage of the annotation data and the association with the video conference data enables the generation of a multitude of types of reports to summarize the stored data.

In summary, the above described invention provides a client-server videoconferencing system having enhanced functionality for providing real-time annotations through a back-channel network, where the annotations are presented to participants through a client. It should be appreciated that the above described system allows for videoconference participants to view annotations, i.e., virtual ink, in real-time, while simultaneously preserving the data generated for future reference and reconstruction. Similarly, the virtual pointer functionality leaves a track that may be recreated for future use. The annotation management system tracks the events occurring during the meeting with respect to annotation/virtual pointer data. Accordingly, these events may be used to provide a detailed summary of the tracked events made during the meeting. It should be appreciated that annotations include adding riotes and comments to any documents shared among videoconference participants and adding notes and drawings to a virtual whiteboard of the videoconference session.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A videoconference system, comprising:
a plurality of clients;
a server component configured to distribute media to the plurality of clients;
a conference channel communication connection over which video and audio data streams are carried between the plurality of clients and the server component;
an annotation management system configured to manage and store annotation data and annotation control data, the annotation management system in communication with the server component; and
a back-channel communication connection over which the annotation data and the annotation control data are communicated between the plurality of clients, the server component and the annotation management system.

2. The videoconference system of claim 1, wherein the back-channel communication connection enables each of the clients to communicate with other clients without disturbing the conference session.

3. The videoconference system of claim 1, wherein each of the plurality of clients execute different videoconference applications.

4. The videoconference system of claim 3, wherein the different videoconference applications are selected from the group consisting of an administrator client application, a conference room client application, a desktop client application, a small device client application, and a small device annotation client application.

5. The videoconference system of claim 1, wherein the annotation data is a note added to one of a document shared by the plurality of clients and a virtual whiteboard shared by the plurality of clients.

6. The videoconference system of claim 1, wherein the annotation management system includes a media management server configured to manage both annotation data and annotation control data communicated between the plurality of clients.

7. The videoconference system of claim 1, wherein upon completion of the videoconference session, the annotation management system is further configured to generate a meeting summarization based upon the annotation data.

8. A videoconferencing system enabling participants to exchange annotation information, comprising:
a server component;
a client configured to execute application software enabling interaction between the client and the server component, the interaction including sharing real-time annotation data between clients; and
an annotation management system in communication with the server component, the annotation management system configured to manage and store the real-time annotation data.

9. The videoconference system of claim 8, wherein the server component is configured to distribute media data to the client over a conference connection path.

10. The videoconference system of claim 9, further comprising:
a back-channel defined between the client and the server component, the back-channel providing a path for the annotation data and the annotation control data to be communicated between the client and the server component.

11. The videoconference system of claim 8, wherein the application software is selected from the group of application software consisting of an administrator client application, a conference room client application, a desktop client application, a small device client application, and a small device annotation client application.

12. The videoconference system of claim 8, wherein the annotation management system includes a media analysis server, the media analysis server configured to associate stored annotation data with stored videoconference session data, the stored annotation data including properties of annotations occurring during the videoconference session.

13. The videoconference system of claim 8, wherein upon completion of a videoconference session between the server component and the client, the annotation management system is further configured to generate a meeting summarization based upon the annotation data.

14. The videoconference system of claim 8, wherein the annotation management server is further configured to manage and store data associated with a virtual pointer.

15. The videoconference system of claim 14, wherein the annotation management server includes,
an event database configured to store both data associated with the virtual pointer and the annotation data;
a storage server configured to store videoconference session data; and
a media analysis server in communication with the event database and the storage server, the media analysis server configured to associate the virtual pointer data and the annotation data with the videoconference session data in order to enable retrieval of the stored videoconference session data based upon one of the virtual pointer data and the annotation data.

16. An annotation management system for providing real-time annotations for media content during a videoconference session, comprising:
a media management server configured to manage both media data and annotation data for distribution to participants of the videoconference session;
a storage server in communication with the media management server, the storage server configured to store the media data and the annotation data;
an event database in communication with the media management server, the event database configured to capture events associated with the annotation data; and
a media analysis server in communication with the media management server, the event database, and the storage server, the media analysis server configured to associate the stored annotation data with the captured events to enable reconstruction of the videoconference session based on the captured events.

17. The annotation management system of claim 16, wherein the media management server includes,
a web service module;
a meeting schedule service module;
an annotation service module; and
a virtual pointer service module.

18. The annotation management system of claim 17, wherein the web service module is configured to enable downloading of software code from a distributed network.

19. The annotation management system of claim 17, wherein the annotation service module is configured to enable one of adding annotation data during the videoconference session and viewing annotation data from a previously recorded videoconference session.

20. A graphical user interface (GUI) enabled to provide real-time annotation of display data rendered on a display screen, the display data associated with a videoconference session, comprising:
a media display region corresponding to a media signal, the media display region capable of being annotated by a videoconference participant, wherein the annotation of the media display region generates an event for storage on an annotation management server, the annotation of the media display region further generating a signal presented to remaining videoconference participants in real-time; and
a control display region enabling a participant to define control properties associated with the media display region.

21. The GUI of claim 20, wherein the media display region includes regions selected from the group consisting of a video display region, a virtual whiteboard region, a control region, and a slide display region.

22. The GUI of claim 20, wherein detection of a selection within the control display region enables adjustment of the control properties.

23. The GUI of claim 20, wherein the control properties include one of audio volume and media display region configuration.

24. A method for providing real-time annotation data to clients of a videoconference session, comprising
annotating a display region of a user interface associated with a client of the videoconference session;
detecting the annotating of the display region;
in response to detecting the annotating of the display region, the method includes, communicating data corresponding to the detecting of the annotating of the display region to other clients of the videoconference session for real-time presentation;
storing the data corresponding to the detecting of the annotating of the display region; and
associating the data corresponding to the detecting of the annotating of the display region with data defining the videoconference session.

25. The method of claim 24, further comprising:
generating a meeting summarization of the data defining the videoconference session based upon the data corresponding to the detecting of the annotating of the display region.

26. The method of claim 24, wherein the method operation of communicating data corresponding to the detecting of the annotating of the display region to other clients of the videoconference session for real-time presentation includes,
transmitting the data corresponding to the detecting of the annotating of the display region from the client to an annotation management system.

27. The method of claim 24, wherein the method operation of storing the data corresponding to the detecting of the annotating of the display region includes,
storing the data defining the videoconference session.

28. The method of claim 24, wherein the method operation of associating the data corresponding to the detecting of the annotating of the display region with data defining the videoconference session includes,
storing the data defining the videoconference session; and
inserting markers into the data defining the videoconference session, the markers indicating one of a starting point of the annotating of the display region and a type of media being annotated.

29. The method of claim 24, wherein the method operation of annotating a display region of a user interface associated with a client of the videoconference session includes,
identifying a region.

30. The method of claim 24, wherein the method operation of identifying a region, includes
distinguishing the region from other regions; and
selecting a control feature, wherein the control feature is selected from the group consisting of display configuration and layout settings, volume settings and muting, selecting and de-selecting media, annotation controls, and virtual pointer controls

31. A computer readable medium having program instructions for providing real-time annotation data to clients of a videoconference session, comprising
program instructions for annotating a display region of a user interface associated with a client of the videoconference session;
program instructions for detecting the annotation of the display region;
program instructions for communicating data corresponding to the detection of the annotation of the display region to other clients of the videoconference session for real-time presentation;
program instructions for storing the data corresponding to the detection of the annotation of the display region; and
program instructions for associating the data corresponding to the detection of the annotation of the display region with data defining the videoconference session.

32. The computer readable medium of claim 31, further comprising:
program instructions for generating a meeting summarization of the data defining the videoconference session based upon the data corresponding to the detecting of the annotating of the display region.

33. The computer readable medium of claim 31, wherein the program instructions for communicating data corresponding to the detecting of the annotating of the display region to other clients of the videoconference session for real-time presentation includes,
program instructions for transmitting the data corresponding to the detecting of the annotating of the display region from the client to an annotation management system.

34. The computer readable medium of claim 31, wherein the program instructions for storing the data corresponding to the detecting of the annotating of the display region includes,
program instructions for storing the data defining the videoconference session.

35. The computer readable medium of claim 31, wherein the program instructions for associating the data corresponding to the detecting of the annotating of the display region with data defining the videoconference session includes,
program instructions for storing the data defining the videoconference session; and
program instructions for inserting markers into the data defining the videoconference session, the markers indicating one of a starting point of the annotating of the display region and a type of media being annotated.
